(19) United States
(12) Patent Application Publication
(10) Pub. No.: US 2003/0025686 A1
(43) Pub. Date: Feb. 6, 2003

(54) Method of automatically refreshing the display screen of a terminal and the computer program thereof

(75) Inventors: Shih-Kai Lee, Taoyuan (TW); Zuo-Jun Shih, Taipei (TW)

Correspondence Address: Haverstock & Owens LLP, 162 North Wolfe Road, Sunnyvale, CA, 94086, US

(73) Assignee: Via Technologies, Inc.

(21) Appl. No.: 10/202,588

(22) Filed: Jul. 23, 2002

(30) Foreign Application Priority Data
Aug. 3, 2001 (TW) 90119042

(51) Int. Cl. G09G 5/00

(52) U.S. Cl. 345/204

(57) ABSTRACT

A method of automatically refreshing the display screen of a terminal and the computer program thereof is accomplished by incorporating a subroutine for periodically polling the connection status of a terminal into a main program running on host. A polling period is set in the main program, and a software interrupt is generated to invoke the execution of a corresponding interrupt service routine when the polling period is reached. The interrupt service routine contains a polling subroutine for polling the connection status of the terminal by sending a control string to the terminal and recording the polling result. The present polling result will be compared with the previous polling result to check whether the connection status of the terminal is changed. If the connection status of the terminal is changed from off-line to on-line, a display screen refresh subroutine is executed to refresh the display screen of the terminal.

### FIELD OF THE INVENTION

The present invention is related to a method of automatically refreshing the display screen of a terminal by a connection between the terminal and a host, and more particularly the present invention is related to a method of periodically polling the connection status of the terminal, and prompting the host to automatically refresh the display screen of the terminal in response to the change of the connection status of the terminal.

### BACKGROUND OF THE INVENTION

For the purpose of permitting a terminal which functions as an user interface to establish a connection with a host, various network connection appliances and equipments have been presented to meet with the requirements of high data transmission rate and stable data transmission quality. As depicted in FIG. 1, a terminal 10 is connected with a host 11 through a transmission cable 12. The transmission cable 12 which may be a RS232C serial interface cable or a universal serial bus (USB) cable, is used to establish a connection for both the terminal 10 and the host 11. When the terminal 10 has been connected with the host 11 through the transmission cable 12, the terminal 10 is able to receive the input data by means of an input device thereof and generate corresponding data signals, and transmit the data signals to the host 11 in response to a request from the host 11. Upon receipt of the data signals by the host 11, the host 11 sends the desired display information to the terminal 10 through the transmission cable 12. After the terminal 10 receives the display information from the host 11, the display information will be shown on the display screen of the terminal 10.

FIG. 2 shows a display screen snapshot of the terminal after the terminal has been connected with a host, for example, a switch. The display screen of the terminal reveals the information in conjunction with the operation of the switch, such as connection port number, connection speed and flow control. Nonetheless, in prior art, when the associated commercially available products are practically operating, the terminal is only responsible for receiving the information from the host, and it will not report its connection status to the host. Therefore the host has no way of getting aware of the connection status of the terminal. In this way, when the connection status of the terminal has been changed, the host is incapable of perceiving that the connection status of the terminal has been changed, and will not perform the display screen refresh process for the terminal.

In operation, according to the prior art, when a user utilizes a terminal to connect with the host and then desires to change the associated connection settings, the host can not perceive that the terminal has been connected, and will not refresh the display screen of the terminal on its own initiative. The user has to look over the blank display screen and keep on waiting. On such occasion, if the user randomly press the keyboard to test if the host can make responses to the user's inputs, the display screen of the terminal will appear like the display screen snapshot of the terminal as shown in FIG. 3, in which the senseless information are displayed.

There is a tendency to look for a way to solve the situation encountered by the prior art that the host can not perceive the change of the connection status of the terminal. Hence, the object of the present invention is to provide a method of automatically refreshing the display screen of a terminal by periodically polling the connection status of the terminal, and refreshing the display screen of the terminal in response to the change of the connection status of the terminal.

### SUMMARY OF THE INVENTION

As mentioned above, in order to allow the host to perceive the connection status of the terminal in good time and automatically refresh the display screen of the terminal in response to the change of the connection status of the terminal, the present invention provides a method of automatically refreshing the display screen of the terminal. The method of automatically refreshing the display screen of the terminal according to the present invention is to incorporate a subroutine for periodically polling the connection status of the terminal and prompting the host to refresh the display screen of the terminal in response to the change of the connection status of the terminal. The method for automatically refreshing the display screen of the terminal according to the present invention includes the step of setting a fixed time interval in the main program running on a host. When the main program is running on the host, it checks whether the fixed time interval is reached to execute the polling subroutine for the terminal. If the fixed time interval is reached, a software interrupt is generated so that the execution of the main program will be interrupted and the corresponding interrupt service routine (also known as “ISR”) is performed.

When the software interrupt is generated, the program will search the interrupt vector table for the interrupt vector corresponding to the interrupt type number of the software interrupt. The interrupt vector indicates the starting address of the interrupt service routine. The interrupt vector table is a special look-up table that saves the interrupt type number and the corresponding interrupt vector, and it occupies a fixed memory space of the host.

When the program finds out the interrupt vector corresponding to the interrupt type number of the software interrupt, the current data values of the data structures that should be reserved so as to ensure the successful execution of the main program when the program execution returns from the interrupt, such as the program counter (PC), status register (SR), etc. are pushed into the stack. The interrupt vector is then loaded into the program counter to execute the interrupt service routine.

Initially, the interrupt service routine sends out a polling string based on the type of the terminal to poll the connection status of the terminal, and saves the present polling record and the previous polling record. If the present polling record reveals that the terminal is currently not connected with the host, the program execution jumps to the end of the interrupt service routine and executes an IRET (return from interrupt) instruction. If the present polling record reveals that the terminal is currently connected with the host, it will be determined whether the terminal is in the initial connection with the host. If the terminal is in the initial connection with the host, the previous connection status of the terminal as indicated by the previous polling record will be set as initial connected, so as to prevent the display screen of the terminal from refreshing one more time when the terminal boots up. Subsequently, the present connection status of the terminal as indicated by the present polling record will be compared with the previous connection status of the terminal as indicated by the previous polling record. If the previous connection status of the terminal is off-line and the present connection status of the terminal is on-line, a display screen refresh subroutine for the terminal will be executed to refresh the display screen of the terminal. After the execution of the display screen refresh subroutine for the terminal is done, the data values of the data structures that were pushed into the stack antecedently, for example, the program counter and the status register, are popped out of the stack in a reverse order at which these data values were pushed into the stack. The program therefore continues at the point in the main program where the interrupt occurred according to the address loaded into the program counter.

Certainly, in accordance with the present invention, the host may be a switch or a hub, and the main program is recorded in an electronic erasable programmable read-only memory (EEPROM) or a flash read-only memory (flash ROM), and is placed into a slot on the main board of the host.

Now the foregoing and other features and advantages of the present invention will be more clearly understood through the following descriptions with reference to the accompanying drawings, wherein:

### BRIEF DESCRIPTION OF THE DRAWINGS

FIG. 1 is a plan view showing a terminal connected with a host by a transmission cable;

FIG. 2 shows a display screen snapshot of the terminal after the terminal has connected with the host;

FIG. 3 shows a display screen snapshot of the terminal as the host is unaware that the connection status of the terminal has been changed, in which the senseless information is displayed;

FIG. 4(A) and FIG. 4(B) are the control flowcharts illustrating the execution of the display screen refresh process for the terminal according to the present invention; and

FIG. 5 shows a display screen snapshot of the terminal after the computer program for automatically refreshing the display screen of the terminal according to the present invention has been implemented on the host.

### DETAILED DESCRIPTION OF THE PREFERRED EMBODIMENT

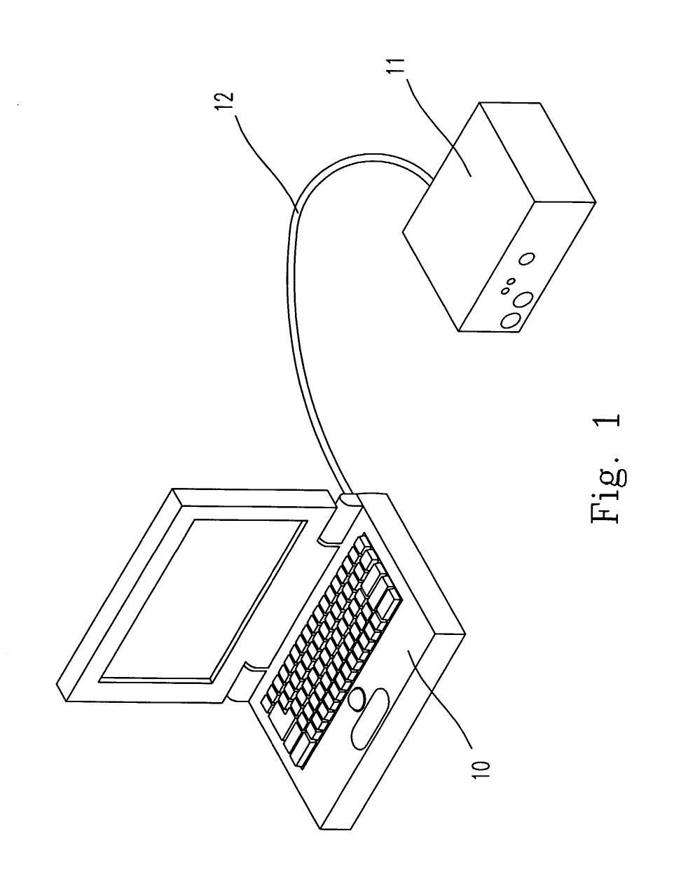

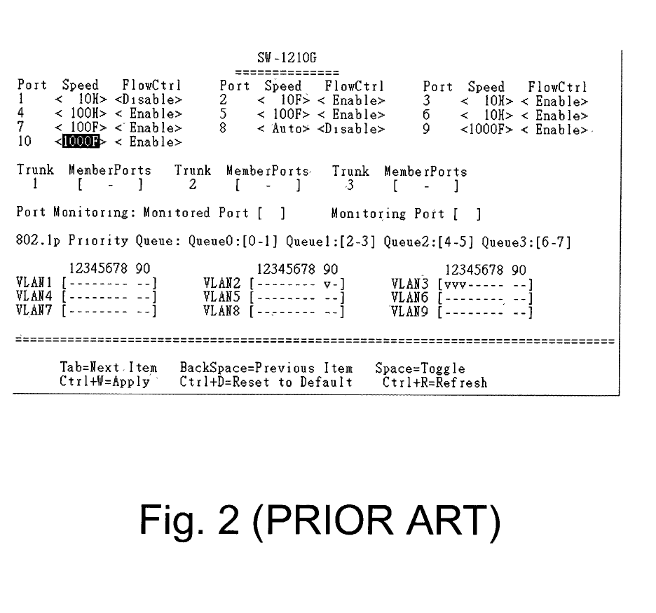

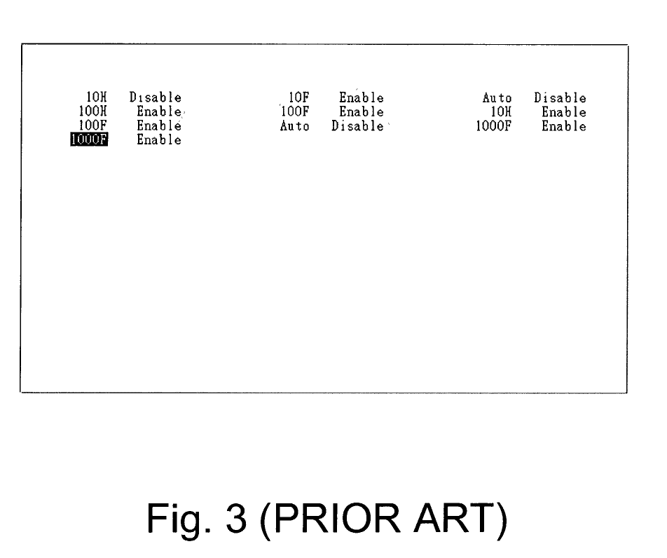

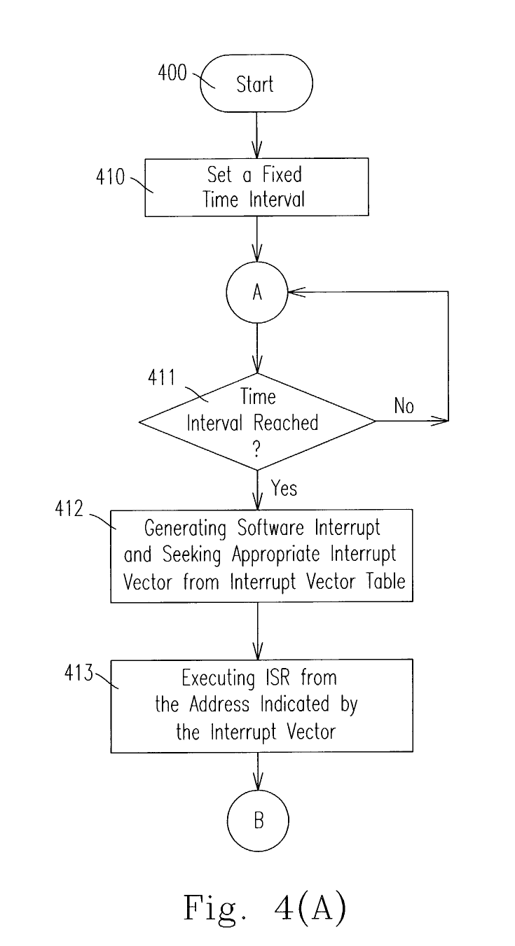

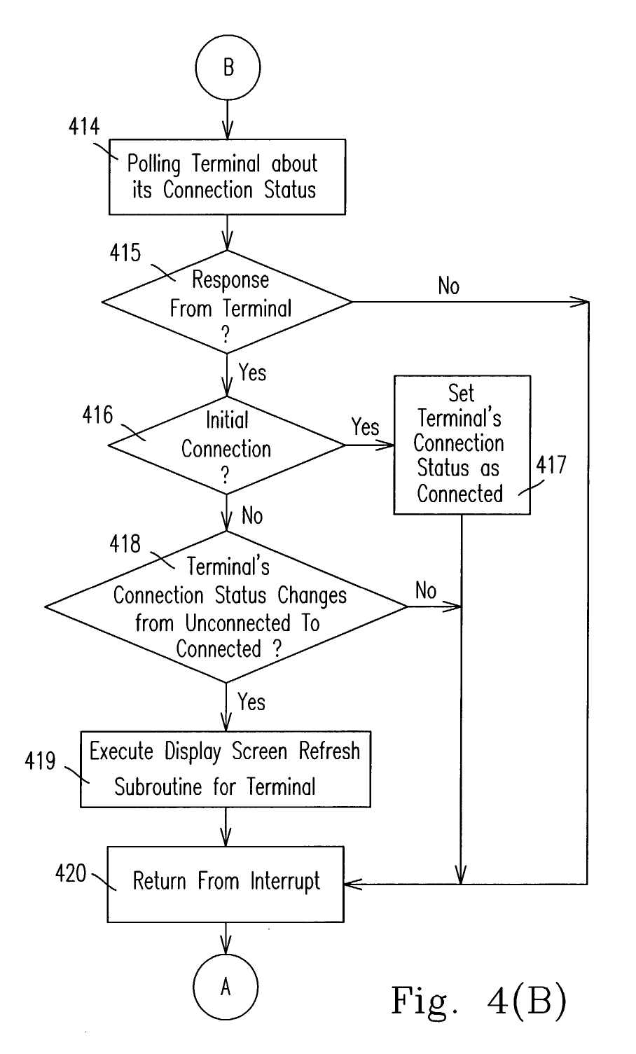

The method of automatically refreshing the display screen of a terminal according to the present invention will be described in detail with reference to the following preferred embodiment together with the plane view of FIG. 1 and the control flowcharts of FIG. 4(A) and FIG. 4(B). The method of identifying the connection status of a terminal according to the present invention is to incorporate a subroutine into the firmware program running on a host, for periodically polling the connection status of the terminal and recording the result indicative of the connection status of the terminal for each polling. The host will determine whether it is necessary to refresh the display screen of the terminal according to the change of the connection status of the terminal as indicated by the polling records. In general, the firmware that is used to configure and drive the hardware component of the host is recorded in a nonvolatile memory (not shown). The nonvolatile memory may be a flash read-only memory (flash ROM) or an electronic erasable programmable read-only memory (EEPROM), and it is placed in an appropriate socket on the main board of the host. In accordance with a preferred embodiment of the present invention, the host may be a switch or a hub.

According to a preferred embodiment of the present invention, in order to eliminate the drawbacks of the prior art that the host is incapable of getting aware of the connection status of the terminal, a subroutine is incorporated into the main program running on the host for periodically polling the connection status of the terminal and automatically refreshing the display screen of the terminal, so that whenever the terminal connects with the host, the terminal can display the up-to-date information about the connection status of the terminal and associated configuration settings.

In relation to the flow chart and algorithm of the subroutine for automatically refreshing the display screen of the terminal, it is intended to be expatiated herein with reference to the flowcharts of FIG. 4(A) and 4(B), and can be fully understood by one skilled in the art in virtue of the following teachings of the preferred embodiment.

The procedure for automatically refreshing the display screen of the terminal starts at step 400. A first variable and a second variable are declared in the main program, and both occupies a fixed memory address in the system memory of the host. The first variable is used to temporarily save the present polling record indicative of the present connection status of the terminal, and the second variable is used to save the previous polling record indicative of the previous connection status of the terminal. In addition to the declaration of the two variables, at step 410 a fixed time interval is set in the main program as the period for prompting the host to poll the connection status of the terminal. At step 411, the main program will check whether the fixed time interval is reached so as to set the main program to start polling the connection status of the terminal for every fixed time interval. If the fixed time interval is reached, a software interrupt instruction will be executed to generate a software interrupt, thereby interrupt the execution of the main program and start to execute the corresponding interrupt service routine (or ISR).

It is apparent from the above statements that the main program will generate a software interrupt for every fixed time interval, so that the execution of the main program may be interrupted and enters into the execution of the display screen refresh procedure for the terminal. When the software interrupt instruction is in execution, the program will search the interrupt vector corresponding to the interrupt type number of the software interrupt from the interrupt vector table.

The interrupt vector table is a look-up table which records the interrupt type number and the corresponding interrupt vector in a fixed memory space of the system memory of the host. The interrupt vector represents an appropriate starting address of an interrupt service routine. The program designer will save the starting address representing the entry of the interrupt service routine in a special table, which is commonly referred to as interrupt vector table. When the software interrupt is requested and generated, the following interrupt sequences will be carried out sequentially. The current values of the status registers will be pushed into the stack, and several control flags in connection with interrupt, such as the interrupt enable flag, will be cleared to mask other interrupts. In addition, the current data value of the program counter which indicates the current program execution address will also be pushed into the stack as a return address. Next, at step 413, the interrupt vector corresponding to the interrupt type number of the software interrupt will be loaded into the program counter to interrupt the execution of the main program and start to execute the specific interrupt service routine.

When the program execution has been entered into the interrupt service routine, the connection status of the terminal will be polled to determine whether it is necessary to refresh the display screen of the terminal. At step 414, the interrupt service routine includes a polling subroutine for sending out a polling string from the host to the terminal to determine whether the terminal is connected with the host or not according to the response of the terminal. Taking the VT100 terminal as an example, among the control sequences of the VT100 terminal, the control sequence of the status report of the terminal can be taken as a knack for polling the connection status of the terminal. With respect to the knack of polling the connection status of a VT100 terminal, for example, can be achieved by the following control sequence:

Status Report

Invoked by ESC [ 5 n

Response is ESC [ 0 n (terminal ok) ESC [ 3 n (terminal not ok)

Accordingly, the host can send the control string of ESC [ 5 n to the terminal, and can be aware of the connection status of the terminal by way of the response of the terminal. At step 415, the response of the terminal will be checked to identify the connection status between the terminal and the host. If the terminal responds to the host with the control string of ESC [ 0 n, it reveals that the terminal is currently in a good connection status with the host. If the terminal responds to the host with the control string of ESC [ 3 n, it reveals that the terminal is currently suffering from some unconquerable problems in establishing a connection with the host. If the terminal does not respond to the host, it reveals that the terminal is currently off-line with respect to the host. From the above discussions, it is to be understood that if the terminal does not respond to the host, the terminal will be identified as off-line with respect to the host, and the host is not necessary to perform the display screen refresh process for the terminal. The execution of the interrupt service routine continues with step 420 by jumping to the end of the interrupt service routine to execute the IRET instruction (return from interrupt), and resuming the execution of the main program where it is interrupted.

Besides, the present polling record and the previous polling record will be respectively recorded in memory addresses indicated by the first variable and the second variable. Next, after the terminal has been identified as online with respect to the host, at step 416 the terminal will be checked if it is in the initial connection with the host. The initial connection setting of the terminal is indicated by a control bit of the second variable, in which the control bit records the previous connection status polled by the host. The program will check the status of this control bit to confirm whether or not the terminal is in the initial connection with the host. If the control bit is confirmed to indicate that the terminal is in initial connection with the host, at step 417 the data value representing that the terminal is connected with the host is saved in the memory address as indicated by the second variable, and the program execution jumps to the end of the interrupt service routine (step 420) to return from interrupt to the main program. The advantage of such software programming design rule is to prevent the display screen of the terminal from refreshing one more time because the connection status of the terminal is identified as changing from off-line to on-line by the subsequent program execution in relation to the determination of the connection status of the terminal.

In FIG. 4(B), at step 418, the previous connection status of the terminal will be compared with the present connection status of the terminal to determine whether it is necessary to refresh the display screen of the terminal. The data value saved in the memory address as indicated by the second variable representing the previous connection status of the terminal will be compared with the data value saved in the memory address as indicated by the first variable representing the present connection status of the terminal, and in response thereto determine whether it is necessary to execute the display screen refresh subroutine for the terminal. If it is found that the connection status of the terminal changes from off-line to on-line, at step 419 the display screen refresh subroutine for the terminal will be executed to refresh the display screen of the terminal. If it is found that the connection status of the terminal changes from on-line to offline, the program execution jumps to the end of the interrupt service routine (step 420) to execute the IRET (return from interrupt) instruction. After the execution of the display screen refresh subroutine for the terminal is finished, at step 420 the execution of the interrupt service routine will be terminated with an IRET (interrupt from interrupt) instruction. When the IRET instruction is executed, the data values of the data structures that were pushed into the stack antecedently, such as program counter or status registers, will be popped out off the stack in a reverse order at which these data values were pushed into the stack and loaded into corresponding data structures. The execution of the main program will be resumed where the interrupt occurred as indicated by the address loaded into the program counter.

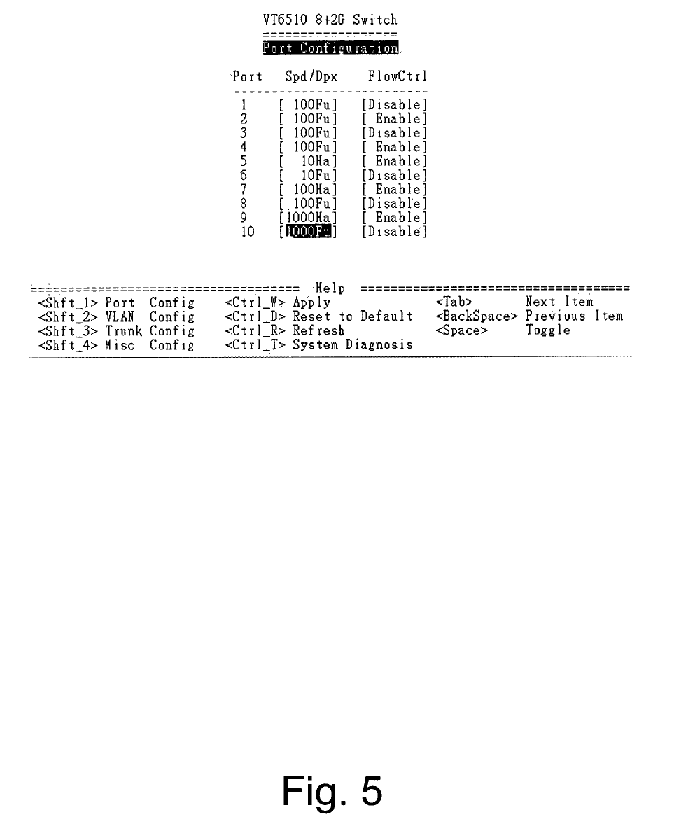

To sum up, the present invention incorporates a subroutine for periodically polling the connection status of the terminal into the main program running on the host, and takes advantages of the software interrupt to invoke the execution of the corresponding interrupt service routine which includes a polling subroutine for polling the connection status of the terminal and a display screen refresh subroutine for refreshing the display screen of the terminal. FIG. 5 shows a display screen snapshot of the terminal after the computer program for automatically refreshing the display screen of the terminal according to the present invention has been implemented on the host. In the light of the computer program of the present invention, the display screen of the terminal is refreshed by the steps of obtaining the connection status of the terminal by periodically polling the connection status of the terminal and refreshing the display screen of the terminal according to the change of the connection status of the terminal. As a result, the terminal will display the latest information about the connection status between the host and the terminal, and thus the annoyance of the user caused by the senseless information on the display screen of the terminal can be eliminated.

Those of skill in the art will recognize that these and other modifications can be made within the spirit and scope of the present invention as further defined in the appended claims.

What is claim is:

1. A method of refreshing a display screen of a terminal by a connection between said terminal and a host, comprising the steps of:
polling a connection status of said terminal by said host;
saving a data value representing a present connection status of said terminal in a first variable indicated by a first memory address;
comparing said data value saved in said first variable indicated by said first memory address with a data value saved in a second variable indicated by a second memory address, wherein said data value saved in said second variable indicated by said second memory address represents a previous connection status of said terminal; and
if said data value saved in said first variable indicated by said first memory address represents a connection status of said terminal as on-line and said data value saved in said second variable indicated by said second memory address represents a connection status of said terminal as off-line, executing a display screen refresh subroutine to refresh said display screen of said terminal.

2. The method as claimed in claim 1 wherein before said step of polling a connection status of said terminal by said host, said method further comprises the steps of:
setting a fixed time interval in a main program running on said host;
checking if said fixed time interval is reached;
if said fixed time interval is reached, generating a software interrupt;
searching an interrupt vector corresponding to an interrupt type number of said software interrupt which is saved in an interrupt vector table, said interrupt vector is indicative of a starting address of an interrupt service routine;
interrupting the execution of said main program and starting to execute an interrupt service routine from a starting address of said interrupt vector.

3. The method as claimed in claim 2 wherein said interrupt vector table is saved in a fixed memory space of a system memory of said host.

4. The method as claimed in claim 2 wherein after said step of polling a connection status of said terminal by said host, said method further comprises the steps of:
checking whether said terminal is in an initial connection with said host; and
if said terminal is in an initial connection with said host, saving a data value representing a connection status of said terminal as off-line in said second variable indicated by said second memory address, and terminating the execution of said interrupt service routine and returning from said interrupt service routine to said main program.

5. The method as claimed in claim 1 wherein said step of polling a connection status of said terminal by said host comprises a step of sending a control string from said host to said terminal.

6. The method as claimed in claim 2 further comprising the steps of:
if said data value saved in said first variable indicated by said first memory address represents a connection status of said terminal as off-line and said data value saved in said second variable indicated by said second memory address represents a connection status of said terminal as off-line, terminating the execution of said interrupt service routine and returning from said interrupt service routine to said main program;
if said data value saved in said first variable indicated by said first memory address represents a connection status of said terminal as off-line and said data value saved in said second variable indicated by said second memory address represents a connection status of said terminal as on-line, terminating the execution of said interrupt service routine and returning from said interrupt service routine to said main program; and
if said data value saved in said first variable indicated by said first memory address represents a connection status of said terminal as on-line and said data value saved in said second variable indicated by said second memory address represents a connection status of said terminal as on-line, terminating the execution of said interrupt service routine and returning from said interrupt service routine to said main program.

7. A computer product having a computer program to be recorded in a nonvolatile memory device, comprising:
a polling means configured to periodically poll a connection status of said terminal by a host;
a comparator means which compares a present polling record indicative of a preset connection status of said terminal and a previous polling record indicative of a previous connection status of said terminal, and in response thereto, outputs a comparison result; and
a display screen refresh means for refreshing a display screen of said terminal in response to said comparison result.

8. The computer product as claimed in claim 7 wherein said host is a switch.

9. The computer product as claimed in claim 7 wherein said host is a hub.

10. The computer product as claimed in claim 7 wherein said nonvolatile memory device is a flash read-only memory.

11. The computer product as claimed in claim 7 wherein said nonvolatile memory device is an electronic erasable programmable read-only memory.
